(19) United States
(12) Patent Application Publication
(10) Pub. No.: US 2008/0216665 A1
(43) Pub. Date: Sep. 11, 2008

(54) HOT WATER UNIT FOR A HOT BEVERAGE MAKER INCLUDING A MILK FOAMER

(76) Inventors: Joachim Hoehne, Burgau (DE); Rolf Gierth, Burgau (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/042,749

(22) Filed: Mar. 5, 2008

(30) Foreign Application Priority Data
Mar. 6, 2007 (DE) 102007010901.8

(51) Int. Cl. A47J 31/44; A23C 3/037; A47J 31/00

(52) U.S. Cl. 99/293; 426/474; 99/287

(57) ABSTRACT

The present invention relates to a hot water unit for a hot beverage maker, in particular a coffee machine provided with a milk foamer, said hot water unit comprising a boiler for providing brewing water and an evaporator for providing steam. The boiler includes a boiler supply, a boiler heating means and a brewing water outlet. The evaporator includes an evaporator supply, an evaporator heating means and a steam outlet. According to the present invention, the boiler and the evaporator are arranged in series, the evaporator supply being implemented as a brewing water supply and connected to the brewing water outlet of the boiler. In addition, the present invention relates to the use of such a hot water unit for connection to a milk roamer and to a hot beverage maker comprising a milk foamer and such a hot water unit.

### PRIORITY

This application claims priority of German Patent Application DE 102007010901.8 filed Mar. 6, 2007, the contents of which is incorporated herein by reference in its entirety.

### FIELD OF THE INVENTION

The present invention relates to a hot water unit for a hot beverage maker, in particular a coffee machine provided with a milk foamer, said hot water unit comprising a boiler for providing brewing water, said boiler including a boiler supply, a boiler heating means and a brewing water outlet, and further comprising an evaporator for providing steam, said evaporator including an evaporator supply, an evaporator heating means and a steam outlet. In addition, the present invention relates to the use of such a hot water unit for connection to a milk foamer and to a hot beverage maker comprising such a hot water unit and a milk foamer.

### BACKGROUND OF THE INVENTION

The devices included in conventional hot beverage makers and used for providing brewing water and/or steam can vary to a great extent. In addition to simple continuous-flow heaters, which provide only a comparatively small volume flow of brewing water, boilers in which a larger amount of brewing water is heated to a desired brewing temperature are used especially in the case of high-quality hot beverage makers. In such boilers, water is normally supplied, by means of a pump, from a cold water reservoir to the boiler via a supply arranged in the lower area of the boiler, whereby heated brewing water will be forced out of the boiler through a brewing water outlet arranged in the upper area of the boiler. In a coffee machine, the heated brewing water flows from the brewing water outlet of the boiler to a filter chamber and from said filter chamber into a cup or pot.

DE 24 05 656 C3, for example, describes such a boiler for preparing brewing water in simple coffee machines; in the case of this boiler the water is supplied laterally in the middle of the boiler. The heating coils of the heating device are arranged in the lower area of the boiler and the brewing water is discharged from the upper area of the boiler through a down-pipe. Another boiler is known from DE 202 18 338 U1. In this boiler, the water is radially supplied to the boiler a short distance above the bottom; mixing of the heated brewing water in the upper part of the boiler with the cold water supplied is reduced by various flow devices.

A further development of this simple boiler technology is disclosed in U.S. Pat. No. 4,565,121. This boiler can be used not only for producing brewing water (at 92° C. to 94° C.) for making hot beverages but also for generating steam (at 110° C. to 120° C. and 1 to 2 bar) so as to foam milk. The brewing water is here led out from the middle of the boiler above the heating coils of the heating means, whereas steam is directed out of the boiler at the lid. For generating steam, the brewing water outlet must be closed by means of a valve and the boiler water must be heated through the heating means to the boiling point so as to provide a sufficient amount of superheated steam. In view of the fact that, for producing steam, the whole content of the boiler will have to be heated, under pressure, up to the boiling temperature, the amount of energy used will, on the one hand, be unnecessarily high and, on the other hand, a longer period of time will be required until steam can actually be taken from the boiler. In addition, when steam has been taken from the boiler, the brewing water temperature prevailing in the boiler will be much too high for preparing coffee so that, when steam has been taken from the boiler, i.e. when milk has been foamed, a cooling interval or an additional rinsing cycle will be required so as to reestablish the necessary lower temperature of the brewing water.

In contrast to the above, hot beverage makers which are easy to handle normally have a boiler for providing brewing water and a separate evaporator for providing steam. Such a hot beverage maker including a hot water unit of the type in question is described in U.S. Pat. No. 5,490,447. Since the hot water unit comprises a boiler as well as a separate evaporator, brewing water and steam can be drawn off independently of one another in an arbitrary sequence, i.e. coffee can be brewed and milk can be foamed. Although such a hot water unit offers a high level of ease for the user, it is necessary to provide two separate water heaters and also all the associated heating means, safety devices as well as connection lines and connections have to be provided twice. This leads to material and assembly costs which are substantially higher than the costs entailed by simple boiler systems and this will result in a high product price that will gain acceptance only in a small market segment.

### SUMMARY OF THE INVENTION

It is therefore the object of the present invention to provide a hot water unit for a hot beverage maker, which can be produced at the lowest possible price and which allows a high level of ease for the user, i.e. a hot water unit which provides brewing water and steam in an arbitrary sequence with the shortest possible waiting times and in unlimited succession.

According to the present invention, this task is solved by the features that the boiler and the evaporator are arranged in series, the evaporator supply being implemented as a brewing water supply and connected to the brewing water outlet of the boiler. This structural design of the hot water unit has the effect that, after the start of operation of the hot beverage maker, the boiler will always contain brewing water having the right brewing water temperature, normally 92° C. to 94° C., so that brewing water for brewing coffee or other hot beverages can be provided at any time. For providing steam by the hot water unit according to the present invention, the evaporator is heated for a short period of time and, after a short waiting time, brewing water from the boiler is supplied to the evaporator where it is evaporated. Since the evaporator has to heat the amount of water required for generating steam only from the comparatively high brewing water temperature to the necessary steam temperature of 110° C. to 120° C. at 1 to 2 bar and evaporate said amount of water, a sufficient amount of steam having the necessary steam temperature can already be provided after a very short waiting time. In view of the fact that the temperature of the brewing water in the boiler is here not influenced or only influenced to an insignificant extent, a withdrawal of brewing water from the hot water unit, immediately after a withdrawal of steam, will be possible; this will be very advantageous, e.g. for preparing latte macchiato or other coffee specialties. In contrast to conventional single-boiler systems, the hot water unit according to the present invention allows an essential enhancement of the ease of use; on the one hand, troublesome waiting times will be eliminated and, on the other hand, the temperature of the brewing water and, in particular, of the steam will be held on the desired temperature levels more effectively so that also the quality of the hot beverages produced by the hot beverage maker will be improved. It is true that, in comparison with expensive systems, the hot water unit according to the present invention can only achieve a minor improvement of the ease of use with regard to the waiting time occurring when the evaporator is heated, but the structural expenditure and the amount of material used will be reduced substantially without any impairment of the ease of use.

For a simple, reasonably-priced structural design the boiler can comprises a boiler housing, the boiler supply being arranged in the lower area of said housing and the brewing water outlet being arranged in the upper area of the housing. Boilers of this kind are already used on a large scale in hot beverage makers and can therefore be procured as a standard component at low production costs. The boiler heating means can be implemented as a multi-stage heating coil which is arranged in the interior of the boiler housing. Multi-stage heating coils are reasonably priced and they can be used with very high efficiency as a heat exchanger in the interior of the boiler housing.

A preferred embodiment is so conceived that the evaporator is implemented as a continuous-flow heater and that it comprises a steam tube between the brewing water supply and the steam outlet. After a short heating phase, such a continuous-flow heater will be able to produce a sufficient amount of superheated steam from the heated brewing water in that the brewing water is first heated in the steam tube, whereupon it is evaporated and the steam is finally superheated. In this way, the continuous-flow heater allows the generation of steam having the quality demanded. It will here be of advantage, when the heater of the evaporator heating means is arranged such that it extends parallel to the steam tube so as to realize a reliable transfer of heat along the whole steam tube with only low heat conduction losses.

Another embodiment is so conceived that the steam tube is arranged such that it is inclined relative to a horizontal siting plane of the hot beverage maker and that the brewing water supply as well as the steam outlet are arranged at the lowermost point of the respective associated steam tube portions of the evaporator when see in relation to the siting plane. The inclination of the steam tube allows reliable draining of the residual water remaining in the evaporator in the steam tube portions following the brewing water supply and the steam outlet, when steam has been drawn off, or of the condensate forming after previous cooling, so that a substantially dry steam tube will be obtained after the end of steam withdrawal or during heating of the evaporator. A dry steam tube prevents an uncontrolled evaporation of condensate or of residual water and the resultant escape or spitting of steam from an overflow or from the steam outlet of the hot beverage maker. An uncontrolled escape of steam or of hot water will not only lead to a negative estimation on the part of the user, but it will also entail a risk of injuries on the part of the user. Due to the inclined arrangement of the steam tube or of the respective associated steam tube portions—what is here meant by inclination is that the plane of the steam tubes in their entirety is inclined relative to the horizontal siting plane of the hot beverage maker and that there are essentially no parts of the steam tube which are not inclined or which extend at least only horizontally—an otherwise necessary additional valve for shutting off the steam outlet can be dispensed with. In conventional systems, such a valve is necessary so as to prevent, for safety reasons, an uncontrolled escape of hot water or steam from the steam outlet at the hot beverage maker when the evaporator is being heated.

The combination of features according to claim 6 could, in connection with the features of claim 4, also enjoy protection independently of one of the claims 1 to 3 and be prosecuted separately. The inclination of an evaporator, which is implemented as a continuous-flow heater and used for providing steam, guarantees, independently of the serial arrangement of the boiler and of the evaporator, that the condensate formed and the residual water remaining in the steam tube will reliably flow off so that, during renewed heating of the evaporator heating means, an uncontrolled escape of hot water or steam from the steam outlet of the hot beverage maker will be prevented and so that it will not be necessary to provide an additional shut-off valve with a draining device for a separate evaporator.

For guaranteeing that the condensate or residual water will drain from the steam tube as reliably as possible, the inclination relative to the horizontal siting plane can be larger than 5°, preferably larger than 10°. In order to allow also a space-saving installation of the evaporator in the hot beverage maker, the inclination relative to the horizontal siting plane can be 90° at the most, but preferably less than 30°. It is of decisive importance that the brewing water inlet and the steam outlet are provided at the respective lowermost position of the associated steam tube portions of the evaporator.

An expedient embodiment is so conceived that the brewing water supply and the steam outlet of the continuous-flow heater are arranged on the same side of the continuous-flow heater. The brewing water supply and the steam outlet are arranged on the same side of the continuous-flow heater, i.e. the connections of the brewing water supply and of the steam outlet are positioned close to one another and parallel to one another or they are arranged at an angle of less than 90° on the evaporator. This mode of arrangement has the effect that installation space for the connections is required in the hot beverage maker only on one side of the continuous-flow heater. This structural design is also easy to assembly and therefore cost-saving. On the basis of an inclined arrangement of the steam tube, the brewing water supply and the steam outlet are arranged on a downward side of the continuous-flow heater when seen in relation to the horizontal siting plane, so that, irrespectively of the shape of the steam tube, the brewing water supply and the steam outlet will be located at the lowermost point of the steam tube. According to the simplest embodiment, the steam tube can be U-shaped. The U-shaped configuration of the steam tube is easy to manufacture on the one hand, and, on the other hand, it also allows the brewing water supply and the steam outlet to be arranged on the same side in a simple manner and it prevents the brewing water supply and the steam outlet, or the connections and conduits of these two components, from interfering with one another. Alternatively, the steam tube can have the shape of a circular arc covering more than 180°, preferably in an approximately closed or fully closed form. An arcuate steam tube having the same area as a U-shaped steam tube extends, in comparison with the latter, also over the region of the open side so that, in all, the length of the heating coil can be enlarged, whereby the surface load on the heater can be reduced while maintaining the same heating power.

Another embodiment is so conceived that a brewing water conduit is provided between the brewing water outlet and the brewing water supply, and that said brewing water conduit is implemented as a flexible, temperature-resistant hose. The use of a hose allows structurally simple solutions which are easy to assemble, since a brewing water conduit implemented as a hose can be placed in a flexible manner between the brewing water outlet and the brewing water supply and since a rigid connection of the components will be avoided in this way.

The present invention additionally comprises the use of one of the above-described hot water units for connection to a milk foamer, the steam outlet of the hot water unit, i.e. of the evaporator, being connected to the milk foamer by means of a shut-off-free steam conduit. The significantly smaller dimensioning of the evaporator, which is connected in series to the boiler, prevents an occurrence of condensate or residual water in the evaporator; an inclined mode of arrangement of the steam tube in question can even fully prevent this. It follows that, when the evaporator is being heated, hot water or steam will be prevented from escaping from the steam outlet of the evaporator or from the milk foamer connected via a shut-off-free steam conduit. An otherwise necessary additional shut-off valve between the steam outlet and the milk foamer, viz. the steam connection of the milk foamer, can be avoided in this way so that a shut-off-free and thus constantly open steam conduit between the steam outlet and the unobstructed milk foamer will be possible. In addition to the fact that a shut-off valve can be dispensed with, the conduit can also be implemented as a flexible and temperature-resistant hose and this will allow a flexible, easy-to-assemble mode of placing said steam conduit.

In addition, the present invention relates to a hot beverage maker, in particular a coffee machine, comprising a milk foamer and one of the above-described hot water units, the milk foamer being connected to the evaporator of the hot water unit in a shut-off-free manner. In addition to the above-described functional and structural advantages of a hot water unit according to the present invention and of the use of a hot water unit for connection to a milk foamer, a hot beverage maker having the structural design in question is reasonably priced due to the simple structural design and, furthermore, it is user-friendly, since the brewing of coffee and the foaming of milk can, irrespectively of the sequence of said operations, be executed an arbitrary number of successive times and without long waiting times. The milk foamer is here connected to the evaporator of the hot water unit in a shut-off free manner, i.e. without an additional shut-off valve which shuts off the steam outlet or the milk foamer supply. The milk foamer is therefore always open. For operating the milk foamer, the evaporator is first heated to the operating temperature and, subsequently, brewing water is conveyed from the boiler into the evaporator where it is evaporated and then supplied to the constantly open milk foamer. For supplying the evaporator with brewing water, a pump can be provided, said pump conveying brewing water from the boiler into the evaporator. When the evaporator has been heated, operation of the pump is started by a signal triggered by the user, whereupon the pump will supply to the evaporator, in a cyclic mode of operation or with a very small volume flow, the small amounts of brewing water required for steam generation. In the case of an inclined arrangement of the steam tube in the evaporator, a pump will always be necessary for conveying the brewing water, against the force of gravity, into the evaporator. In order to prevent the water volume, which will increase in size during heating of the boiler, from entering the evaporator, an overflow means must be provided in the boiler or between the boiler and the evaporator; this overflow means conducts the additional water volume as overflow water back into a fresh water tank or leads it to a drain. Without such overflow means, the enlarged water volume may enter the evaporator and cause an uncontrolled escape of hot water or steam from the milk foamer; this will have to be avoided at all events for reasons of safety.

### DESCRIPTION OF THE DRAWINGS

The drawings enclosed show an embodiment of the present invention which will be explained in more detail in the following.

FIG. 1 shows a perspective view of a hot water unit according to the present invention having a milk foamer connected thereto; and

FIG. 2 shows a side view of the hot water unit according to FIG. 1 with a mounting frame.

### DETAILED DESCRIPTION

The hot water unit shown in the drawings is the core of a hot beverage maker, used in particular for a coffee machine. This hot water unit essentially consists of a boiler 1 and an evaporator 2, said evaporator 2 being connected to a milk foamer 3. The boiler 1 has a housing 4 which is normally made of sheet metal and which comprises a cold water supply 5 arranged in the lower housing part and an outlet 6 projecting from the upper housing part. The lower and upper housing parts are interconnected in the middle by a flange 7, produced especially by welding or crimping. The flange 7 additionally serves to fix the boiler 1 in position in the hot beverage maker. The housing 4 of the boiler 1 is substantially cylindrical and oriented such that its axis of rotation is upright, an angular deviation of said axis of rotation from the vertical of up to 20° being possible, without any functional problems arising, so as to allow freer positioning of the boiler 1 in the beverage maker. The cold water supply 5 and the brewing water outlet 6 are arranged on the bottom and on the lid of the boiler 1, respectively, and they are aligned coaxially with the axis of rotation of the housing 4. The bottom of the housing 4 has provided thereon not only the cold water supply 5 but also connections 8 for a heating coil (not shown) which is arranged in said housing 4. Furthermore, a temperature sensor 9 is provided below the flange 7, said temperature sensor 9 being accommodated in a sensor retainer 10 which is fixedly anchored in the housing 4. The temperature sensor 9 extends through an opening in the housing 4 into the brewing water contained in the boiler 1 and is normally sealed off from the sensor retainer 10 by means of an O-ring. Two independently operative protective temperature limiters 11, which are arranged on the level of the interior heating coil, are provided below the temperature sensor 9 along the periphery of the boiler 1 such that they are displaced relative to one another. As soon as the wall temperature of the boiler 1 rises above a specific temperature level, one of said, or both of said protective temperature limiters 11 will interrupt the current input of the boiler heating means. Apart from the brewing water outlet 6, the upper part of the housing 4 is not provided with any other connections or functional elements.

The brewing water outlet 6 of the boiler 1 is connected via the brewing water conduit 12, which is here implemented as a flexible and temperature-resistant hose, to the evaporator supply 13 of the evaporator 2. In addition, the brewing water outlet 6 is also connected to respective coffee or hot beverage makers (not shown) as well as to a return tube leading into the fresh water tank (neither of them shown). The evaporator supply 13 opens into a U-shaped steam tube 14, which extends in the evaporator 2 in a bend up to the steam outlet 15. On the inner side of the U-shaped steam tube 14, a heating element 16 is arranged in contact with said steam tube 14. The heating element 16 extends parallel to the steam tube 14 over the entire length thereof and is embedded in an evaporator housing 17 together with said steam tube 14. The ends of the heating element 16, which project beyond the evaporator housing 17, have provided thereon terminals 18 for connecting said heating element 16 to a voltage source. The upper side of the evaporator housing 17 has arranged thereon a temperature sensor 19, which measures the temperature of the steam tube 14 and which allows an effective control of the heating element 16.

The steam outlet 15 of the evaporator 2 is followed by a steam conduit 20, which is here again implemented as a flexible and temperature-resistant hose and which connects the evaporator 2 to the milk foamer 3. The steam conduit 20 opens directly into the steam connection 21 of the milk foamer. The milk foamer 3 is additionally provided with a laterally arranged milk connection piece 22 as well as with a nozzle 23 for discharging the milk foam.

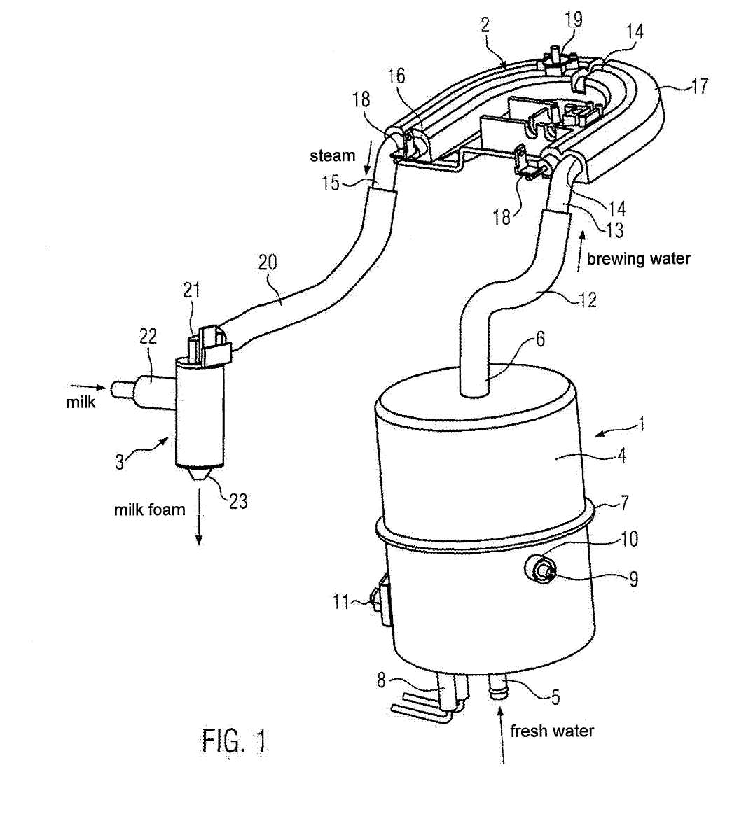

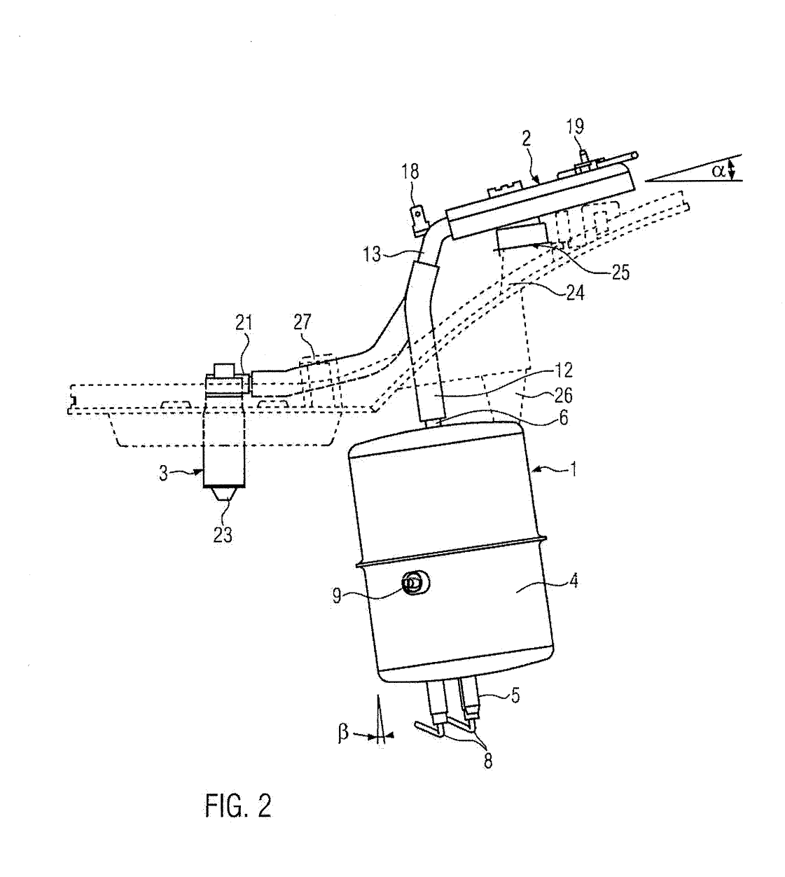

FIG. 2 shows a side view of the hot water unit according to FIG. 1, which again has the milk foamer 3 connected thereto and which is additionally provided with a mounting frame 24 on which the boiler 1, the evaporator 2 and the milk foamer 3 are mounted. The frame 24 allows fixing of the evaporator 2 via a respective holder 25 as well as the arrangement of the boiler 1 via an arm 26 and of the milk foamer 3 within the frame 24 itself. In addition, the frame 24 also offers possibilities of fixing the brewing water conduit 12 and the steam conduit 20 with the aid of suitable clips 27 and of accommodating, if desired, a brewing device (not shown), e.g. adjacent the milk foamer 3.

The evaporator 2 is inclined by an angle α of approx. 13° relative to a horizontal siting plane which corresponds to the orientation of the front part of the frame 24 accommodating the milk foamer 3. The brewing water supply 13 as well as the steam outlet 15 of the evaporator 2 are arranged at the lowest point of the steam tube 14 so as to guarantee that residual water and condensate will flow off from the steam tube 14. Furthermore, also the axis of rotation of the boiler 1 is inclined by an angle β of approx. 9° relative to the vertical axis of the beverage maker. The convex lid of the boiler 1 will here also reliably prevent the formation of an undesired air cushion in the boiler 1.

In the following, the mode of operation of the hot water unit comprising the boiler 1 and the evaporator 2 will be explained in more detail on the basis of FIG. 1. The boiler 1 has supplied thereto fresh water from a reservoir (not shown) via the cold water supply 5 of the boiler 1 by means of a pump (not shown), said fresh water being normally distributed in the lower part of the boiler 1 by means of a flow distribution unit (not shown). The fresh water entering the boiler 1 flows past the heating coil, which is preferably implemented as a multi-stage component, and rises, in a heated condition, into the upper part of the boiler 1. The brewing water, which has been heated to the brewing temperature, in the upper part of the boiler 1 is forced out of the brewing water outlet 6 by the fresh water flowing into the lower part of the boiler 1.

The temperature sensor 9 extends through the sensor retainer 10 into the boiler 1 so as to determine, through direct contact with the brewing water, the temperature of the latter and so as to send a corresponding signal to a control unit of the boiler heating means. The sensor 9 is arranged above the last turn of the heating coil so as to allow a temperature measurement for the brewing water contained in the upper part of the boiler 1 which is only influenced to a minor extent through the heating of the water by the heating coil.

Depending on the requirement to be fulfilled, the brewing water forced out of the boiler 1 via the brewing water outlet 6 is conducted to a respective brewing unit (not shown) or the evaporator 2. If milk foam is required, the steam tube 14 of the evaporator 2 is first heated to its operating temperature via the heating element 16. The heating of the steam tube 14 to its operating temperature is supervised by the temperature sensor 19. When the operating temperature of the evaporator 2 has been reached, a small amount of brewing water having the brewing temperature of 92° C. to 94° C. is supplied by means of the pump through the brewing water conduit 12 and the brewing water supply 13 to the evaporator 2. In the steam tube 14, the brewing water is first heated to the boiling temperature, whereupon it is evaporated and finally superheated so as to provide the steam temperature of 110° C. to 120° C. at 1 to 2 bar, which is required for foaming the milk. The superheated steam is discharged from the steam tube 14 of the evaporator 2 at the steam outlet 15 and is conducted through the steam conduit 20 to the steam connection 21 of the milk foamer 3. The steam entering the milk foamer 3 sucks in milk through the milk connection piece 22 according to the Venturi principle, mixes with the sucked-in milk in the milk foamer 3, heats said milk simultaneously and is discharged at the nozzle 23 in the form of milk foam. Since steam generation necessitates only a comparatively small volume flow of brewing water, the performance of the pump, which normally has to convey large amounts of brewing water also in coffee or tea brewing processes, must be reduced or clocked so as to avoid excessive supply rates.

When a preselected pump operation period for the preparation of milk foam has come to an end, the residual water contained in the evaporator 2 is fully evaporated so that, after the end of the process, the steam tube 14 will be essentially dry. Due to the inclined position of the evaporator 2 and due to the fact that the brewing water supply 13 and the steam outlet 15 are arranged on the downwards directed side of the evaporator 2, residual water amounts which may perhaps remain in the evaporator 2 and any condensate that may be formed will be removed from the sloping areas of the steam tube 14 due to the effect of the force of gravity.

What is claimed is:

1. A hot water unit for a hot beverage maker comprising a boiler for providing brewing water, said boiler including a boiler supply, a boiler heating means and a brewing water outlet, and further comprising an evaporator for providing steam, said evaporator including an evaporator supply, an evaporator heating means and a steam outlet, wherein the boiler and the evaporator are arranged in series, the evaporator supply being implemented as a brewing water supply and connected to the brewing water outlet of the boiler.

2. A hot water unit according to claim 1, wherein the boiler comprises a boiler housing, the boiler supply being arranged in the lower area of said housing and the brewing water outlet being arranged in the upper area of the housing.

3. A hot water unit according to claim 2, wherein the boiler heating means is implemented as a multi-stage heating coil which is arranged in the interior of the boiler housing.

4. A hot water unit according to claim 1, wherein the evaporator is implemented as a continuous-flow heater and that it comprises a steam tube between the brewing water supply and the steam outlet.

5. A hot water unit according to claim 4, wherein the heater of the evaporator heating means is arranged such that it extends parallel to the steam tube.

6. A hot water unit according to claim 4, wherein the steam tube is arranged such that it is inclined relative to a horizontal siting plane of the hot beverage maker and that the brewing water supply as well as the steam outlet are arranged at the point of the respective associated steam tube portions representing the lowermost point in relation to the siting plane.

7. A hot water unit according to claim 6, wherein the inclination relative to the horizontal siting plane is larger than 5°, preferably larger than 10°.

8. A hot water unit according to claim 7, wherein the inclination relative to the horizontal siting plane is 90° at the most, but preferably less than 45°, in particular less than 30°.

9. A hot water unit according to claim 4, wherein the brewing water supply and the steam outlet of the continuous-flow heater are arranged on the same side of the continuous-flow heater.

10. A hot water unit according to claim 9, wherein the steam tube is U-shaped.

11. A hot water unit according to claim 9, wherein the steam tube has the shape of a circular arc.

12. A hot water unit according to claim 1, wherein a brewing water conduit is provided between the brewing water outlet and the brewing water supply, and that said brewing water conduit is implemented as a flexible and temperature-resistant hose.

13. The use of a hot water unit according to claim 1 for connection to a milk foamer, wherein the steam outlet of the hot water unit is connected to the milk foamer by means of a shut-off-free steam conduit.

14. The use of a hot water unit according to claim 13, wherein the steam conduit is implemented as a flexible and temperature-resistant hose.

15. A hot beverage maker, in particular a coffee machine, comprising a milk foamer and a hot water unit according to claim 1, wherein the milk foamer is connected to the evaporator of the hot water unit in a shut-off-free manner.

16. A hot beverage maker according to claim 15, wherein a pump is provided, said pump conveying brewing water from the boiler into the evaporator.

17. A hot beverage maker according to claim 16, wherein an overflow means is provided, and that the overflow means is arranged in the boiler or between the boiler and the evaporator.
